(19) United States
(12) Patent Application Publication
(10) Pub. No.: US 2013/0212511 A1
(43) Pub. Date: Aug. 15, 2013

(54) APPARATUS AND METHOD FOR GUIDING HANDWRITING INPUT FOR HANDWRITING RECOGNITION

(71) Applicant: Samsung Electronics Co., Ltd., (US)

(72) Inventors: Jung-Rim KIM, Gyeonggi-do (KR); Woo-Sung KANG, Gyeonggi-do (KR); Sang-Ho KIM, Gyeonggi-do (KR)

(73) Assignee: Samsung Electronics Co., Ltd., Gyeonggi-do (KR)

(21) Appl. No.: 13/757,315

(22) Filed: Feb. 1, 2013

(30) Foreign Application Priority Data
Feb. 9, 2012 (KR) 10-2012-0013169

(51) Int. Cl. G06F 3/0488

(52) U.S. Cl. CPC G06F 3/04883
USPC 715/771

(57) ABSTRACT

An apparatus and method for guiding handwriting input for handwriting recognition are provided. The method includes storing at least one character data item and at least one character feature information item corresponding to respective character data; detecting upon input of a first touch-and-drag, at least one first feature information item from a trajectory drawn according to the input first touch-and-drag; comparing the detected at least one first feature information item with the at least one character feature information item; detecting at least one first character data candidate having at least one same character feature information item as the detected at least one first feature information item; and displaying the detected at least one first character data candidate.

### PRIORITY

This application claims priority under 35 U.S.C. §119(a) to a Korean Patent Application filed in the Korean Intellectual Property Office on Feb. 9, 2012 and assigned Serial No. 10-2012-0013169, the entire content of which is incorporated herein by reference.

### BACKGROUND OF THE INVENTION

1. Field of the Invention

The present invention relates generally to an apparatus and method for guiding handwriting input, and more particularly, to an apparatus and method for guiding handwriting input based on a trajectory drawn by user's handwriting input.

2. Description of the Related Art

Generally, handwriting recognition is used to recognize handwriting input via a pointing device such as a touch screen or a digitizer.

More specifically, conventional handwriting recognition recognizes the order of a trajectory drawn through a touch-and-drag input by sensing a contact or a pressure of an object, such as a user's finger or a pen, through a touch screen. For example, a coordinate string may be calculated according to the order of an input trajectory by using an 8-way chain code, and the calculated coordinate string is patterned, such that the modeled pattern is compared with a preset handwriting recognition engine. The most similar pattern found as a result of comparison is displayed as a recognition result.

In other words, conventional handwriting recognition determines the coordinate string according to the input order and the input trajectory based on touch-and-drag inputted by a user.

As such, conventionally, the handwriting order and handwriting input direction of the user are patterned together, and the patterned data is compared with a preset handwriting recognition pattern, such that the most matched pattern is displayed as a recognition result.

However, since an input order based on the user's touch input is recorded, if handwriting input is made with a wrong input order (i.e. a different order of input resulting in a similar input shape), a recognition engine fails to recognize the input handwriting, resulting in a low recognition rate.

As a result, in various instances where a user may input handwriting in a wrong order, such as when a user has to input a foreign character, but does not know the conventional order of making strokes of the character, handwriting input by the user is difficult to recognize with conventional handwriting recognition.

### SUMMARY OF THE INVENTION

Accordingly, the present invention provides an apparatus and method for guiding handwriting input to a user based on a trajectory drawn by user's handwriting input.

According to an aspect of the present invention, an apparatus for guiding handwriting input for handwriting recognition is provided. The apparatus includes a touch screen for displaying a screen and receiving a touch input and drag input; a character feature database for storing at least one character data item and at least one character feature information item corresponding to respective character data; and a controller for detecting, upon input of a first touch-and-drag through the touch screen, at least one first feature information item from a trajectory drawn according to the input first touch-and-drag, comparing the at least one detected first feature information item with the at least one character feature information item, detecting at least one first character data candidate having at least one same character feature information as the detected at least one first feature information item, and displaying the detected at least one first character data candidate through the touch screen.

According to another aspect of the present invention, a method for guiding handwriting input for handwriting recognition is provided. The method includes storing at least one character data item and at least one character feature information item corresponding to respective character data; detecting, upon input of a first touch-and-drag, at least one first feature information item from a trajectory drawn according to the input first touch-and-drag; comparing the detected at least one first feature information item with the at least one character feature information item; detecting at least one first character data candidate having at least one same character feature information item as the detected at least one first feature information item; and displaying the detected at least one first character data candidate.

### BRIEF DESCRIPTION OF THE DRAWINGS

The above and other features and advantages of embodiments of the present invention will be more apparent from the following detailed description taken in conjunction with the accompanying drawings, in which:

FIG. 1 is a block diagram illustrating a handwriting input guiding apparatus including a touch screen according to an embodiment of the present invention;

FIG. 2 is a flowchart illustrating a process of storing character feature information, which is used to guide handwriting input, and optical character information in a correspondence manner according to an embodiment of the present invention;

FIG. 3 is a flowchart illustrating a process of guiding handwriting input according to an embodiment of the present invention;

FIG. 4 is a flowchart illustrating a process of guiding handwriting input when user's handwriting is additionally input according to an embodiment of the present invention; and

FIG. 5 is a diagram illustrating a screen for guiding handwriting input in response to user's handwriting input according to an embodiment of the present invention.

### DETAILED DESCRIPTION OF THE EMBODIMENTS OF THE PRESENT INVENTION

Hereinafter, embodiments of the present invention are described in detail with reference to the accompanying drawings. In addition, a detailed description of well-known functions and constructions may be omitted if such a description obscures the subject matter of the present invention.

An apparatus performing a method according to an embodiment of the present invention extracts at least one character feature information item from at least one optical character and stores the extracted at least one character feature information item and each optical character in a correspondence manner, and detects first feature information from a trajectory drawn by handwriting input. The apparatus then compares the detected first feature information with previously stored character feature information, detects at least one optical characters having the same character feature information as the first feature information, and displays the detected optical characters in an overlapping manner based on the position of the drawn trajectory, thereby guiding handwriting input regardless of the order of handwriting input of a user.

In the following description, an optical character refers to, but not limited to, a character converted by scanning an image of a character, which is written by a person or printed by a machine, with an image scanner to allow a machine to read that character. A character according to the present invention may be an arbitrary digital character to be compared with a character handwritten by a user or a portion of the character in character recognition.

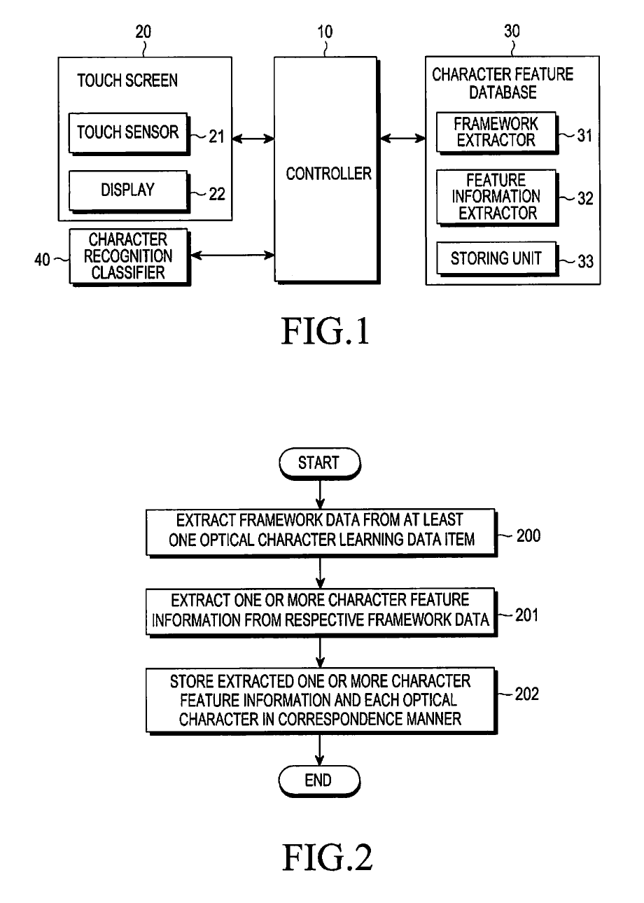

FIG. 1 is a block diagram of a handwriting input guiding apparatus including a touch screen according to an embodiment of the present invention.

Referring to FIG. 1, the handwriting input guiding apparatus includes a controller 10, a touch screen 20, a character feature database 30, and a character recognition classifier 40.

The controller 10 controls overall operations of the handwriting input guiding apparatus, and in particular, extracts at least one character feature information item from at least one optical character and stores the extracted at least one character feature information item and each optical character in a correspondence manner through the character feature database 30.

More specifically, the controller 10 extracts framework data from at least one optical character learning data item stored in a storing unit 33 through a frame extractor 31 of the character feature database 30. Herein, framework data refers to data that expresses the optical character learning data as a maximally compressed skeleton line.

The controller 10 extracts at least one character feature information item from the respective extracted framework data through a feature information extractor 32, and stores the extracted at least one character feature information item and each optical character in a correspondence manner in the storing unit 33. The character feature information includes information such as length rate, angle, direction, and relative position of the framework data. For example, in the present example according to an embodiment of the present invention, for an optical character ‘ [symbol] ’, character feature information includes angle information, including 180° and 90°, based on respective strokes and direction information including horizontal and vertical directions of the respective strokes.

In response to a request for executing a handwriting input mode, the controller 10 executes the handwriting input mode for performing recognition corresponding to handwriting input. The handwriting input mode includes an operation mode for guiding handwriting input according to user's handwriting input.

Upon input of a first touch-and-drag or a first touch-and-drag-and-drop through the touch screen 20, the controller 10 detects first feature information from a trajectory drawn according to the first touch-and-drag input or the first touch-and-drag-and-drop input. The first feature information includes information such as length, ratio, angle, direction, and relative position of the drawn trajectory.

The controller 10 compares the detected first feature information with at least one character feature information item stored in the character feature database 30 to detect at least one first optical character candidate having the same character feature information as the detected first feature information. For example, if a drawn trajectory is ‘—’, the controller 10 detects angle information such as 180° and direction information such as the horizontal direction, and detects first optical character candidates having the horizontal direction as character feature information. The detected optical character candidate may include “—”, “T”, “ [symbol] ”, “ [symbol] ”, “ [symbol] ”, “ [symbol] ”, etc.

The controller 10 displays the detected at least one first optical character candidate in an overlapping manner based on the position of the drawn trajectory through a display 22 of the touch screen 20.

Upon receiving input of a second touch-and-drag or a second touch-and-drag-and-drop through the touch screen 20, the controller 10 detects second feature information from a trajectory drawn according to the second touch-and-drag input or the second touch-and-drag-and-drop input. For example, if a drawn trajectory is a diagonal trajectory, such as a “/”, the controller 10 may further detect angle information of the angle of the trajectory, such as 45°.

The controller 10 detects at least one second optical character candidate having the same character feature information as the second feature information from among the displayed first optical character candidates. According to another embodiment of the present invention, the controller 10 compares the detected second feature information with previously stored at least one character feature information item to detect at least one second optical character candidate having both the detected first feature information and the same character feature information as the second feature information.

The controller 10 displays, from among the at least one first optical character candidate, only a first optical character candidate that is matched to the detected second optical character candidates.

The controller 10 displays optical character candidates that can be classified by the character recognition classifier 40, from among the displayed at least one optical character candidate, on a predetermined display region to allow the user to select a character to be input.

The touch screen 20 includes a touch sensor 21 and the display 22, and the touch sensor 21 senses user's touch input, generates a sensing signal, and transmits the sensing signal to the controller 10. The touch sensor 21 may be any of a variety of types of touch sensors, including, but not limited to, a capacitive overlay type, a resistive overlay type, an infrared beam type, a pressure sensor, etc. The touch sensor 21 may be any type of a sensor capable of sensing contact or pressure of an object.

The display 22, which may be implemented with a Liquid Crystal Display (LCD), visually provides menus, input data, function setting information and other various information of a portable terminal to the user. For example, the display 22 may output a booting screen, a standby screen, a display screen, a call screen, and other application execution screens of a portable terminal.

The character feature database 30 includes the framework extractor 31, the feature information extractor 32, and the storing unit 33. The framework extractor 31 extracts framework data from at least one optical character learning data item stored in the storing unit 33. The feature information extractor 32 extracts at least one character feature information item from respective framework data. The storing unit 33 stores the extracted at least one character feature information item and each optical character in a correspondence manner.

The character recognition classifier 40 determines which character candidates can be classified from among the at least one optical character displayed in an overlapping manner. For example, when a displayed optical character candidate is “ [symbol] ”, the character recognition classifier 40 may determine character candidates “ [symbol] ”, “ [symbol] ”, “ [symbol] ”, “ [symbol] ”, etc.

FIG. 2 is a flowchart illustrating a process of storing character feature information that is used to guide handwriting input, and an optical character in a correspondence manner according to an embodiment of the present invention.

Referring to FIG. 2, in step 200, the controller 10 extracts framework data from at least one optical character learning data item stored in the storing unit 33 through the framework extractor 31 of the character feature database 30.

In step 201, the controller 10 extracts at least one character feature information item from the extracted respective framework data through the feature information extractor 32.

In step 202, the controller 10 stores the extracted at least one character feature information item and each optical character in a correspondence manner in the storing unit 33. The character feature information includes information such as length rate, angle, direction, and relative position of framework data.

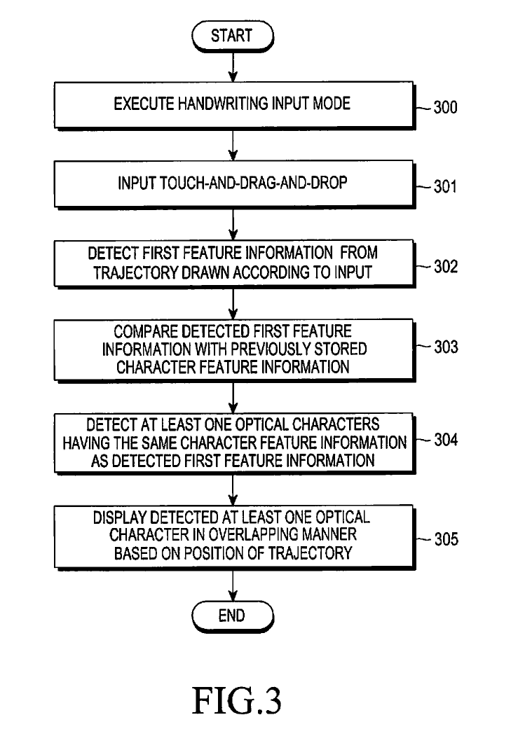

FIG. 3 is a flowchart illustrating a process of guiding handwriting input according to an embodiment of the present invention.

Referring to FIG. 3, in step 300, in response to a request for executing a handwriting input mode, the controller 10 executes the handwriting input mode for performing recognition corresponding to handwriting input. The handwriting input mode includes an operation mode for guiding handwriting input according to user's handwriting input.

Upon input of a first touch-and-drag or a first touch-and-drag-and-drop through the touch screen 20 in step 301, the controller 10 detects first feature information from a trajectory drawn according to the first touch-and-drag input or the first touch-and-drag-and-drop input, in step 302. The first feature information includes information such as length, ratio, angle, direction, and relative position of the drawn trajectory.

In step 303, the controller 10 compares the detected first feature information with at least one character feature information item stored in the character feature database 30.

In step 304, the controller 10 detects at least one optical character candidate having the same character feature information as the detected first feature information.

In step 305, the controller 10 displays the detected at least one optical character candidate in an overlapping manner based on the position of the drawn trajectory on the display 22 of the touch screen 20.

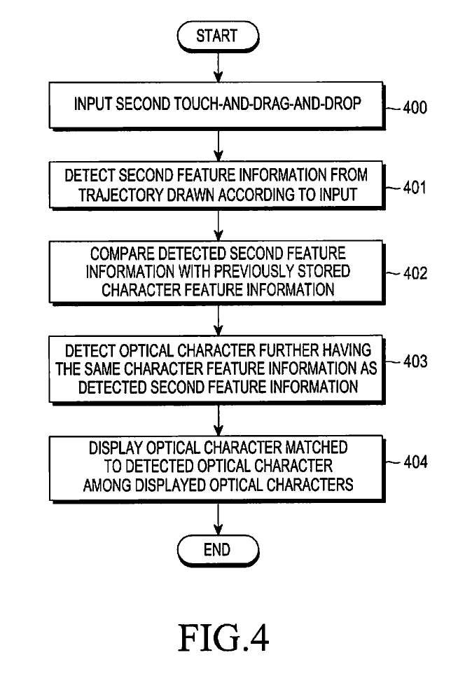

FIG. 4 is a flowchart illustrating a process of guiding handwriting input when a user's handwriting is additionally input, according to an embodiment of the present invention.

Referring to FIG. 4, in step 400, upon input of a second touch-and-drag or a second touch-and-drag-and-drop through the touch screen 20, the controller 10 detects second feature information from a trajectory drawn according to the second touch-and-drag input or the second touch-and-drag-and-drop input. For example, if a drawn trajectory is “/”, the controller 10 may further detect angle information of a corresponding angle, such as 45°.

In step 402, the controller 10 compares the detected second feature information with previously stored at least one character feature information item.

In step 403, the controller 10 detects at least one optical character candidate further having the same character feature information as the detected second feature information. More specifically, the controller 10 detects at least one optical character candidate having both the first feature information and the second feature information.

In step 404, the controller 10 displays only an optical character candidate that is matched to the detected optical character candidates from among the displayed at least one optical character candidate.

The controller 10 displays, from among the displayed at least one optical character candidate, optical character candidates that can be classified by the character recognition classifier 40 on a predetermined display region.

As such, according to an embodiment the present invention, feature information of a trajectory generated by user's touch input is compared to predetermined character feature information, and at least one character candidate having the same character feature information is displayed as the predetermined character feature information, allowing the user to easily perform handwriting input regardless of the order of making strokes.

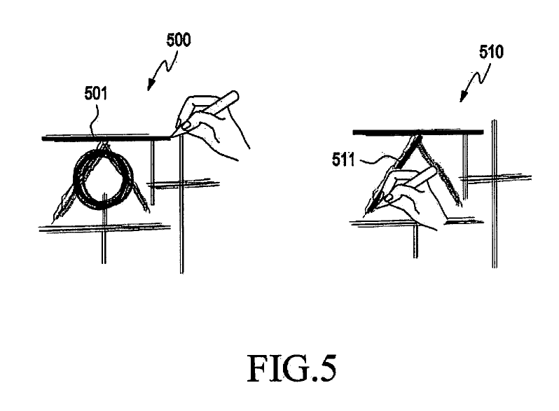

FIG. 5 is a diagram illustrating a screen for guiding handwriting input in response to user's handwriting input according to an embodiment of the present invention.

Referring to FIG. 5, upon receiving input of a handwriting stroke 501 as shown in a first screen 500, the controller 10 extracts first feature information from a trajectory drawn according to the handwriting stroke 501 (i.e., a first touch-and-drag input), compares the extracted first feature information with previously stored character feature information, and displays optical character candidates having the same character feature information as the extracted first feature information in an overlapping manner.

Upon receiving further input of a handwriting stroke 511 as shown in second screen 510, the controller 10 extracts second feature information from a trajectory drawn according to the second handwriting stroke 511 (i.e., a second touch-and-drag input), and displays optical character candidates further having the same character feature information as the extracted second feature information in an overlapping manner.

As is apparent from the foregoing description, feature information of a trajectory generated by user's touch input is compared with predetermined character feature information, and at least one character candidate having the same character feature information as the predetermined character feature information are displayed, thus allowing a user to easily perform handwriting input regardless of the order of inputting strokes.

Moreover, embodiments of the present invention can clearly recognizing handwriting even when the user performs handwriting input regardless of the order of making strokes.

Embodiments of the present invention are not limited to the foregoing embodiments and the accompanying drawings, and various substitutions, modifications, and changes can be made by those of ordinary skill in the art without departing from the technical spirit of the present invention as defined by the appended claims and their equivalents.

What is claimed is:

1. An apparatus for guiding handwriting input for handwriting recognition, the apparatus comprising:
a touch screen for displaying a screen and receiving a touch input and drag input;
a character feature database for storing at least one character data item and at least one character feature information item corresponding to respective character data; and
a controller for detecting, upon input of a first touch-and-drag through the touch screen, at least one first feature information item from a trajectory drawn according to the input first touch-and-drag, comparing the at least one detected first feature information item with the at least one character feature information item, detecting at least one first character data candidate having at least one same character feature information as the detected at least one first feature information item, and displaying the detected at least one first character data candidate through the touch screen.

2. The apparatus of claim 1, wherein the character feature database extracts framework data from the at least one character data item, extracts the at least one character feature information item from the extracted framework data, and stores the extracted at least one character feature information item and the respective character data in a correspondence manner.

3. The apparatus of claim 1, wherein the at least one character feature information item includes at least one of length rate information, angle information, direction information, and relative position information of each stroke of the at least one character data item.

4. The apparatus of claim 1, wherein the controller displays the detected at least one first character data candidate in an overlapping manner based on a position of the trajectory.

5. The apparatus of claim 1, wherein the controller detects, upon input of a second touch-and-drag through the touch screen, at least one second feature information item from a trajectory drawn according to the input, detects at least one second character data candidate further having at least one same character feature information item as the detected at least one second feature information item from among the displayed at least one first character data candidate, and displays the detected at least one second character data candidate.

6. A method for guiding handwriting input for handwriting recognition, the method comprising:
storing at least one character data item and at least one character feature information item corresponding to respective character data;
detecting, upon input of a first touch-and-drag, at least one first feature information item from a trajectory drawn according to the input first touch-and-drag;
comparing the detected at least one first feature information item with the at least one character feature information item;
detecting at least one first character data candidate having at least one same character feature information item as the detected at least one first feature information item; and
displaying the detected at least one first character data candidate.

7. The method of claim 6, wherein storing the at least one character feature information item comprises:
extracting framework data from the at least one character data item;
extracting the at least one character feature information item from the extracted framework data; and
storing the extracted at least one character feature information item and the respective character data in a correspondence manner.

8. The method of claim 6, wherein the at least one character feature information item includes at least one of length rate information, angle information, direction information, and relative position information of each stroke of the at least one character data item.

9. The method of claim 6, wherein displaying the at least one first character data candidate comprises displaying the detected at least one first character data candidate in an overlapping manner based on a position of the trajectory.

10. The method of claim 6, further comprising:
detecting, upon input of a second touch-and-drag, at least one second feature information item from a trajectory drawn according to the input,
detecting at least one second character data candidate further having at least one same character feature information item as the detected at least one second feature information item from among the displayed at least one first character data candidate; and
displaying the detected at least one second character data candidate.
